(19) United States
(12) Patent Application Publication
(10) Pub. No.: US 2024/0331069 A1
(43) Pub. Date: Oct. 3, 2024

(54) SYSTEM AND METHOD FOR INTERACTIVE REAL ESTATE TRANSACTIONS

(71) Applicant: Relotz Holdings, LLC, Douglasville, GA (US)

(72) Inventor: Charlie Hightower, Douglasville, GA (US)

(73) Assignee: Relotz Holdings, LLC, Douglasville, GA (US)

(21) Appl. No.: 18/620,891

(22) Filed: Mar. 28, 2024

Related U.S. Application Data
(60) Provisional application No. 63/492,723, filed on Mar. 28, 2023.

(51) Int. Cl. G06Q 50/16; G06Q 30/0601

(52) U.S. Cl. CPC G06Q 50/167; G06Q 30/0609; G06Q 30/0631; G06Q 30/0643

(57) ABSTRACT

The system and methods disclosed provide a platform system, including software (e.g., portals) a backend system that can be used to provide computer-based real estate transactions directly between a buyer and an owner/seller of real estate property. The platform can coordinate a real estate transaction, for example negotiating an offer to purchase a real estate property, directly between the buyer and the owner/seller of the property in a manner that eliminates the requirement of a human real estate agent to serve as an intermediary between the buyer and the owner/seller during the transaction process. Thus, the technology platform efficiently, securely, and interactively manages the end-to-end real estate transaction process (e.g., offer and sale of a real estate property) directly between a buyer and an owner/seller.

### FIELD OF DISCLOSURE

The present disclosure generally relates to interactive negotiation, particularly a wireless communication-based platform that facilitates negotiations between users related to real estate, such as offers and contracts to purchase real estate.

### BACKGROUND OF THE DISCLOSURE

The proliferation of electronic commerce (e-commerce) and online business practices have enabled many areas of businesses, including real estate, to move away from cumbersome manual processes to more efficient wireless communication-based (e.g., Internet) transactions. Although some initiating aspects of real estate negotiations can be completed online directly between a buyer and seller, most existing Internet-based systems, and methods of performing and managing real estate negotiations still require the involvement and/or intermediation of one or more human real estate agents in order to fully complete the negotiations (e.g., complete sale of a real estate property). However, there are some instances where it is not necessary for a human real estate agent to act as an intermediary between the buyer and seller. For example, there is no law in California that requires that home buyers must be represented by a real estate professional during a purchase transaction. In fact, many people choose to buy a house on their own, without an agent, and for a variety of reasons. Consequently, it may be beneficial to provide an computer-based system that supports interactive negotiations related to real estate to be completed directly between a buy and a seller, without the overhead of involvement of real estate agents, and in a manner that leverages the effective use of electronic/online capabilities throughout the full lifecycle of performing real estate negotiations. The same or similar problems also exist in other contexts, such construction, service contexts and the like. Accordingly, there is a long felt but unmet need in the art for technology which can address one or more of the drawbacks of presently existing techniques for performing and managing real estate transactions.

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an example of a communication system in which embodiments disclosed herein may be implemented for providing a real estate transaction platform system, according to one or more embodiments shown and described herein.

FIG. 2 illustrates an example architecture for the real estate transaction platform system shown in FIG. 1, according to one or more embodiments shown and described herein.

FIG. 3 depicts an example of a method for implementing a computer-based real estate transaction process, according to one or more embodiments shown and described herein.

FIG. 4-FIG. 26 illustrate example graphical user interfaces that may be implemented by portals of the real estate transaction platform system shown in FIG. 1, according to one or more embodiments shown and described herein.

FIG. 27 depicts an example of a computer system that may be used in implementing the real estate transaction platform system, according to one or more embodiments shown and described herein.

### DETAILED DESCRIPTION OF THE DISCLOSURE

The present disclosure includes many aspects and features. Moreover, while many aspects and features relate to, and are described in, the context of a wireless platform providing interactive real estate transactions, embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

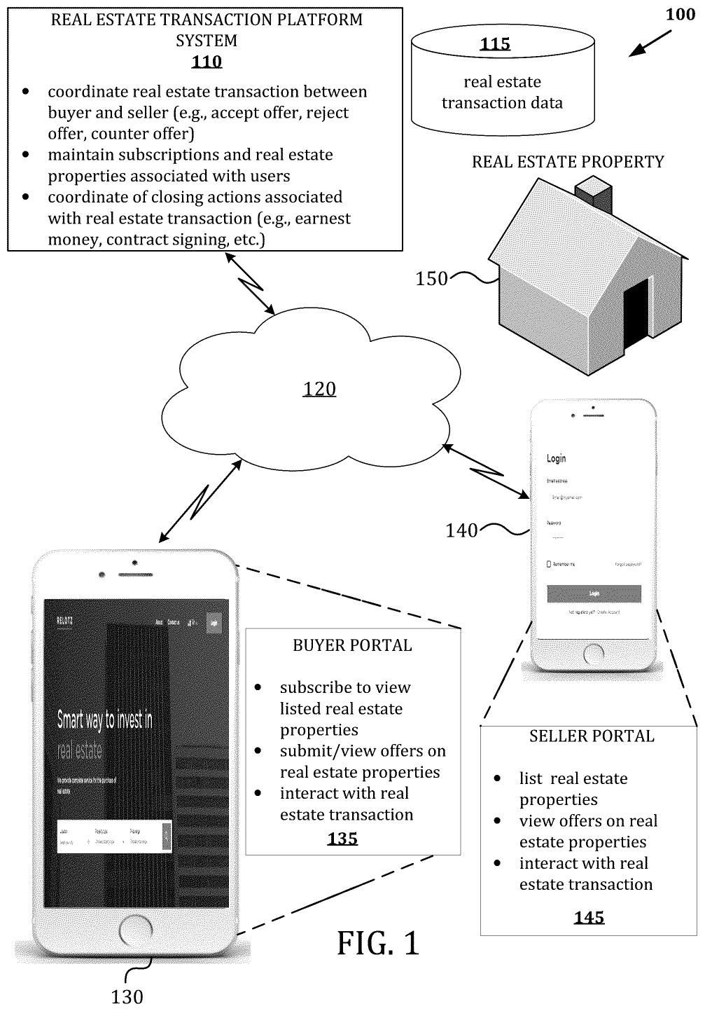

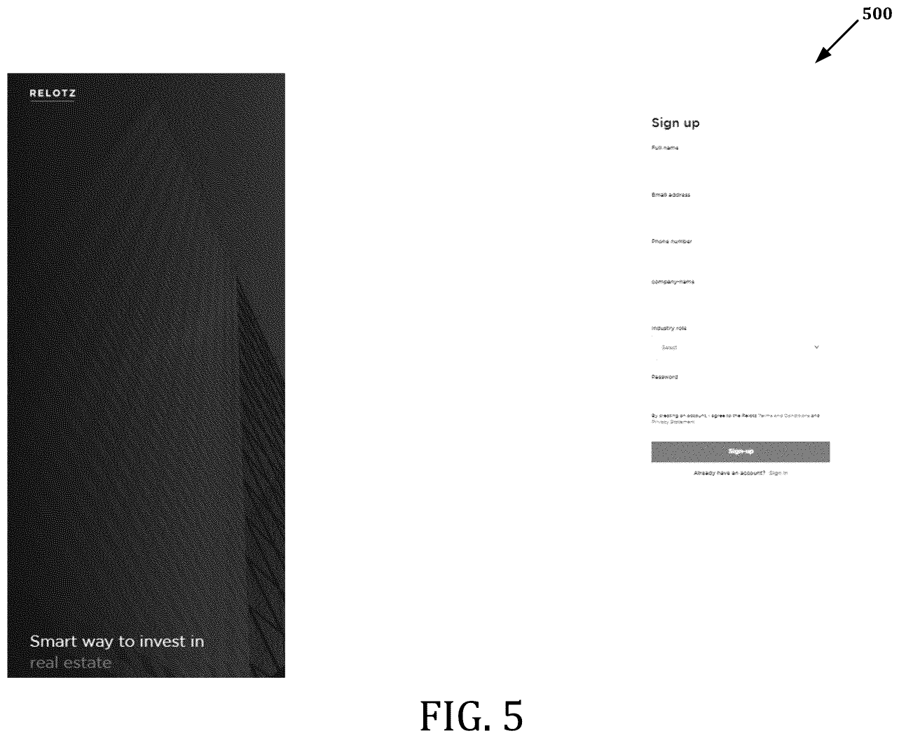

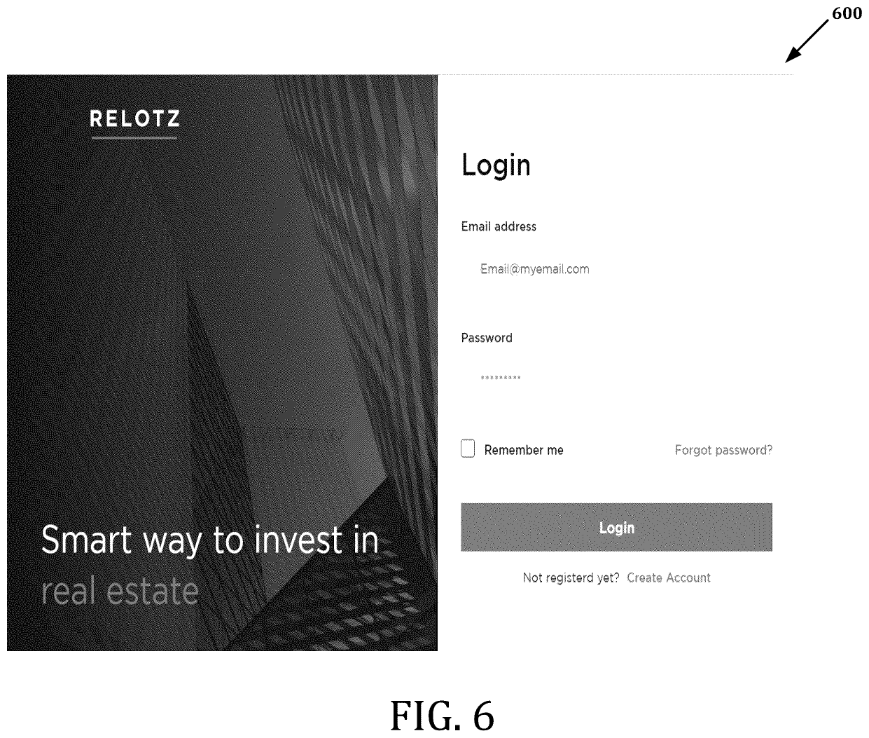

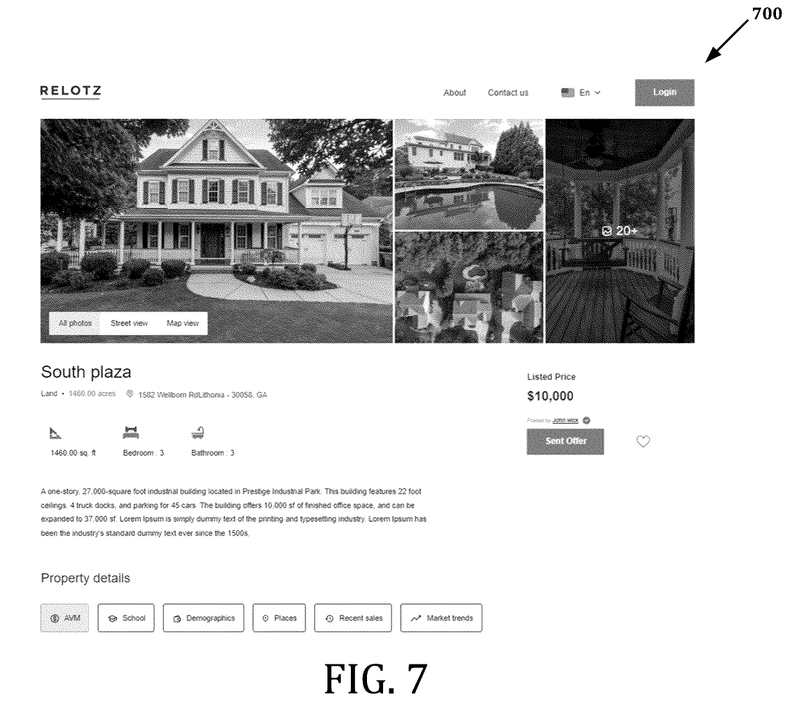

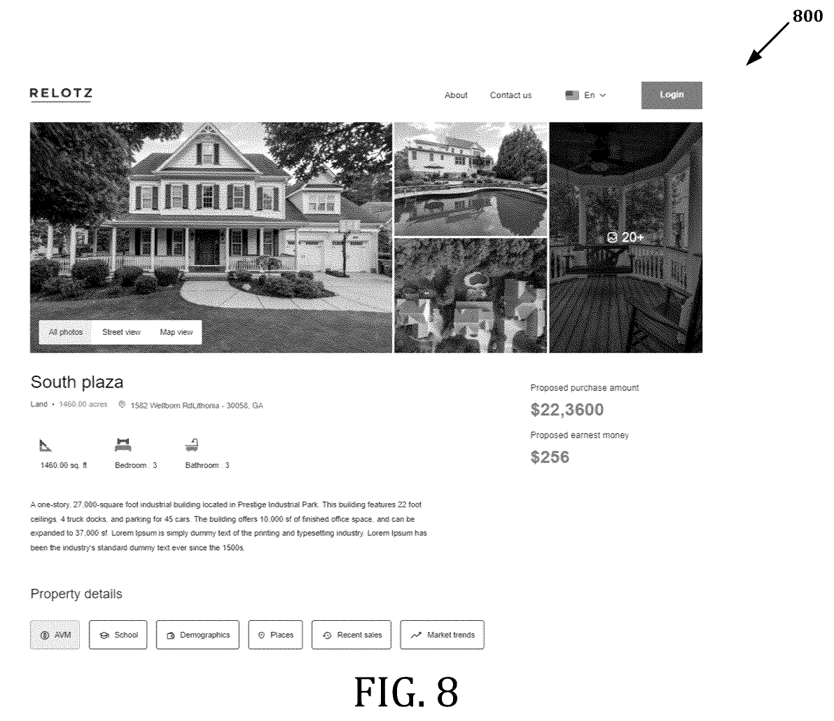

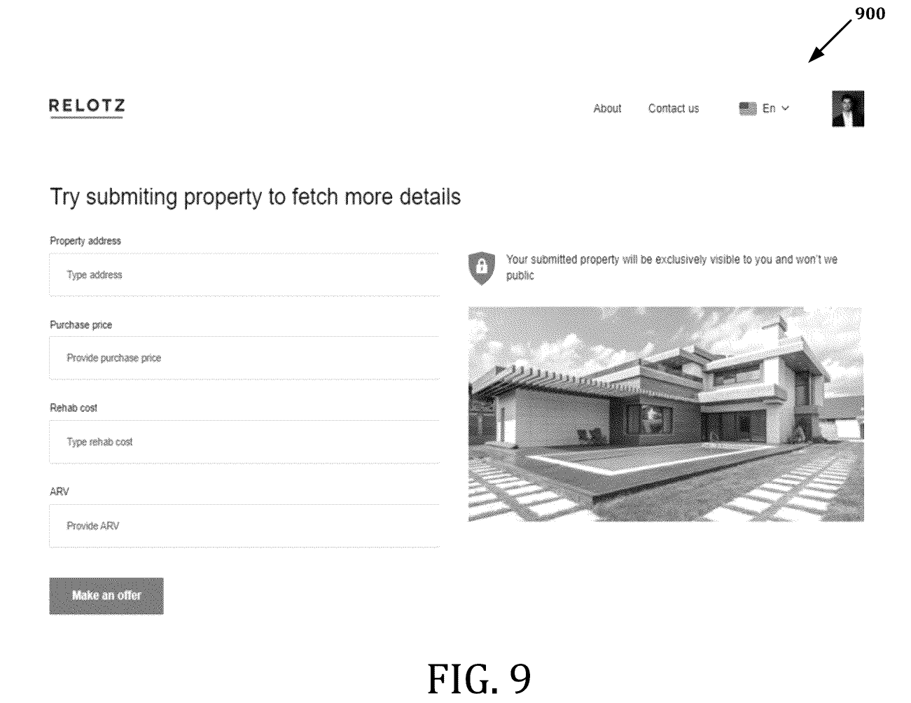

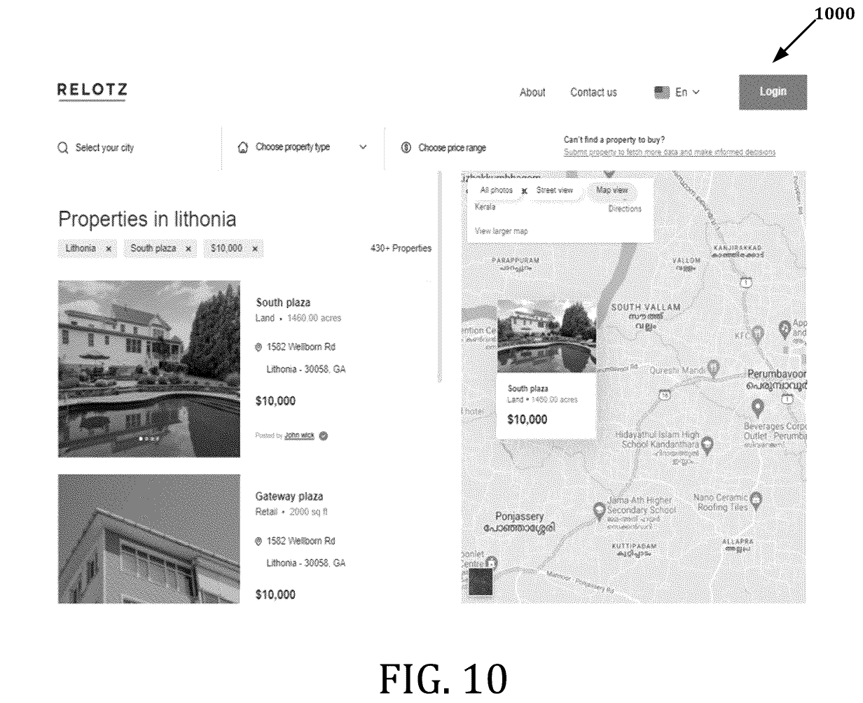

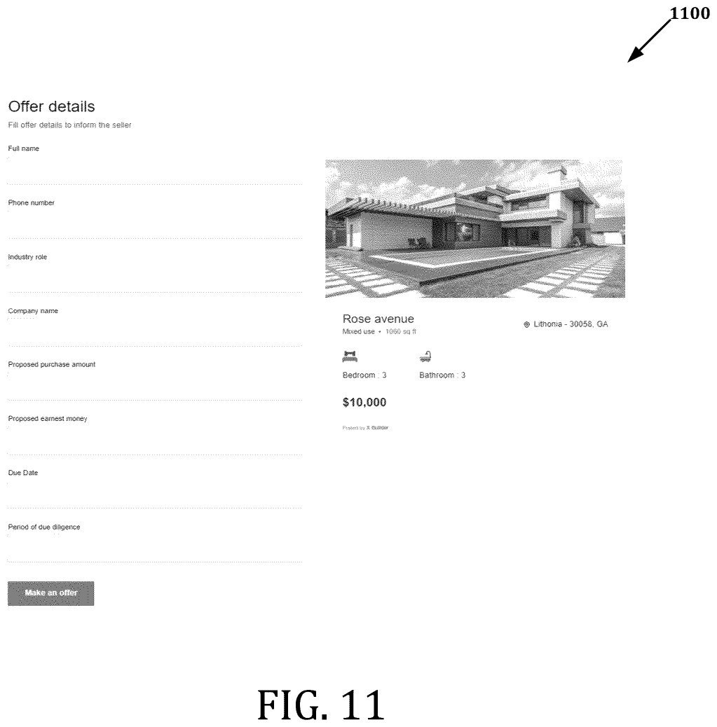

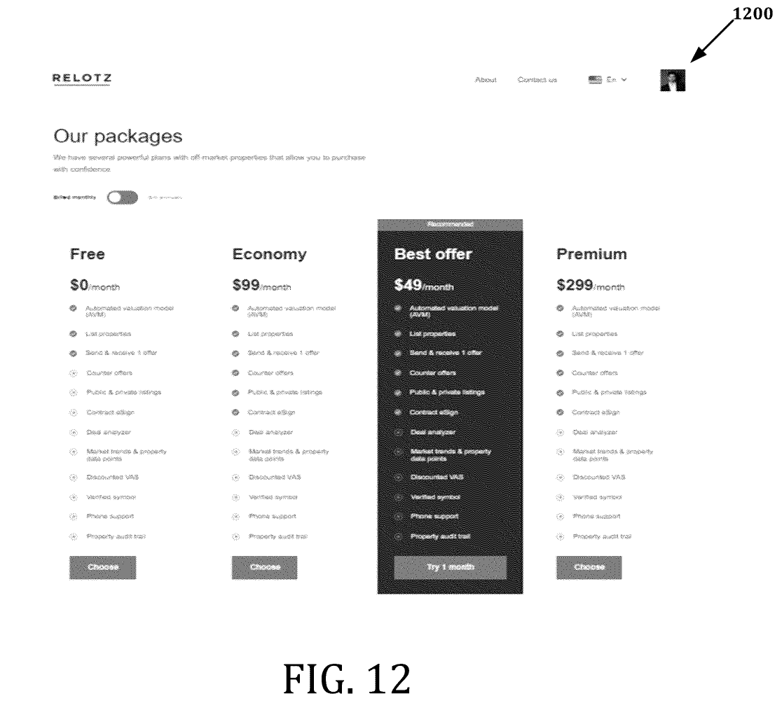

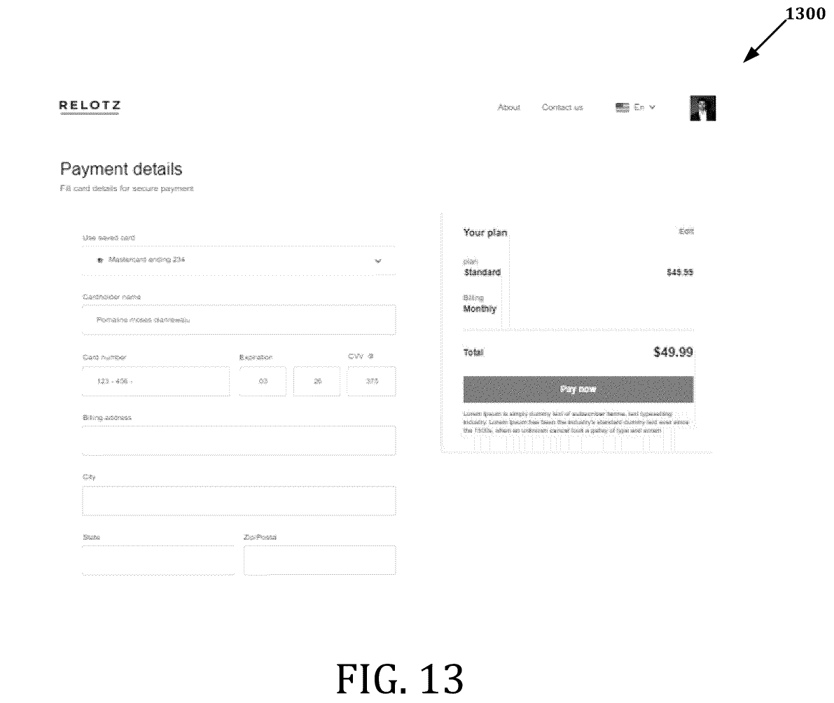

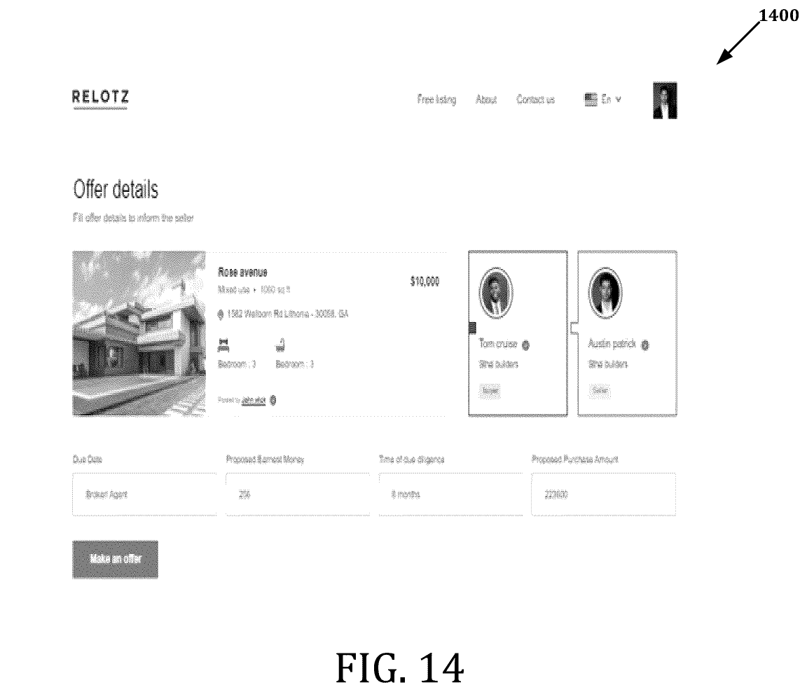

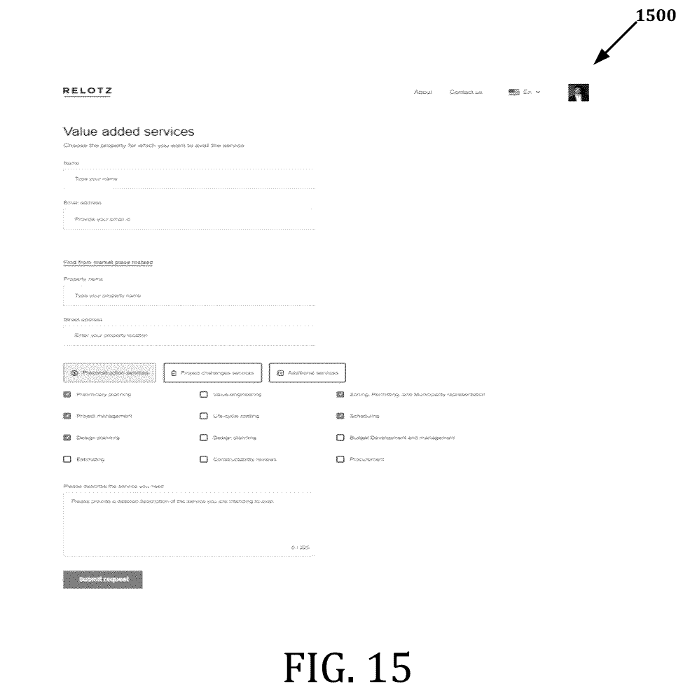

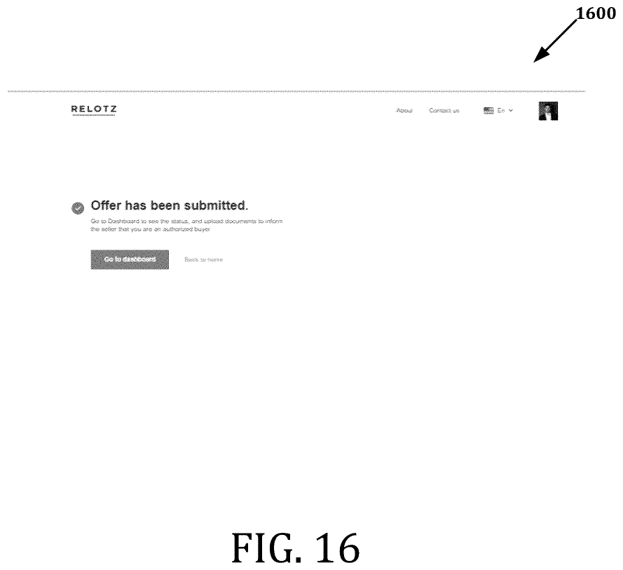

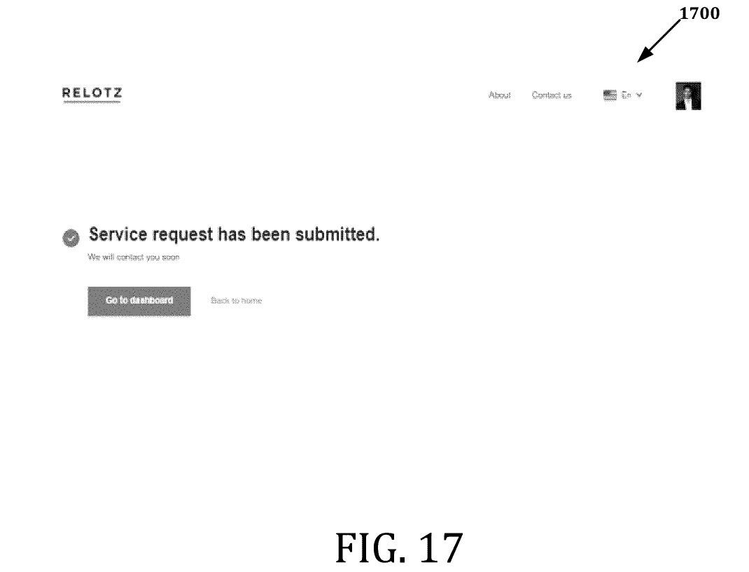

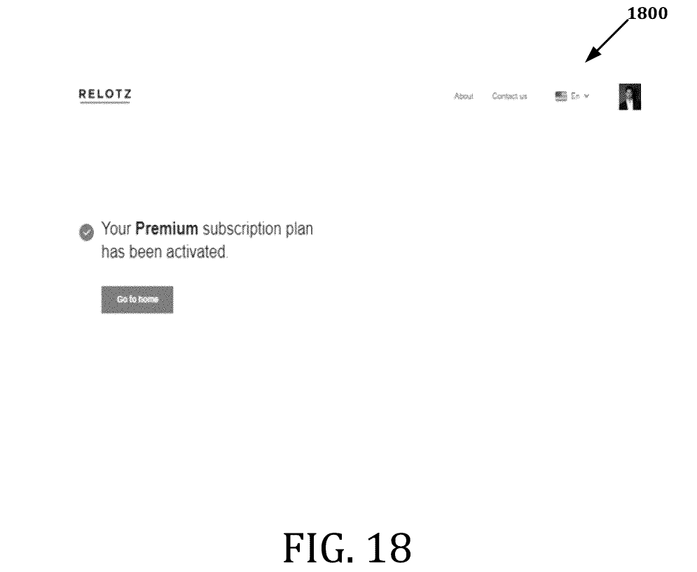

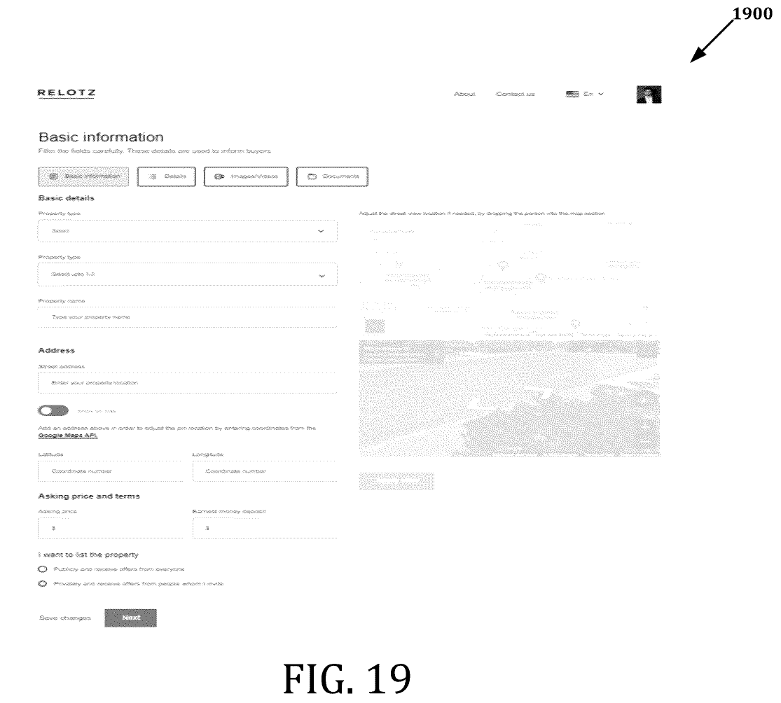

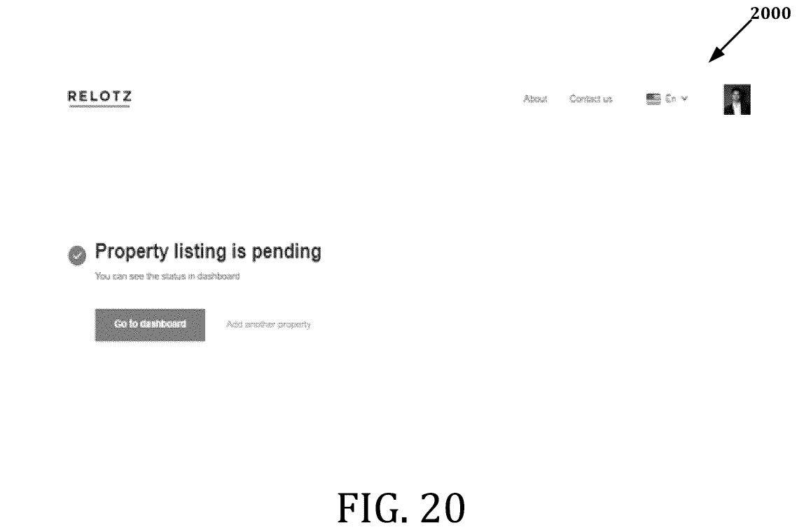

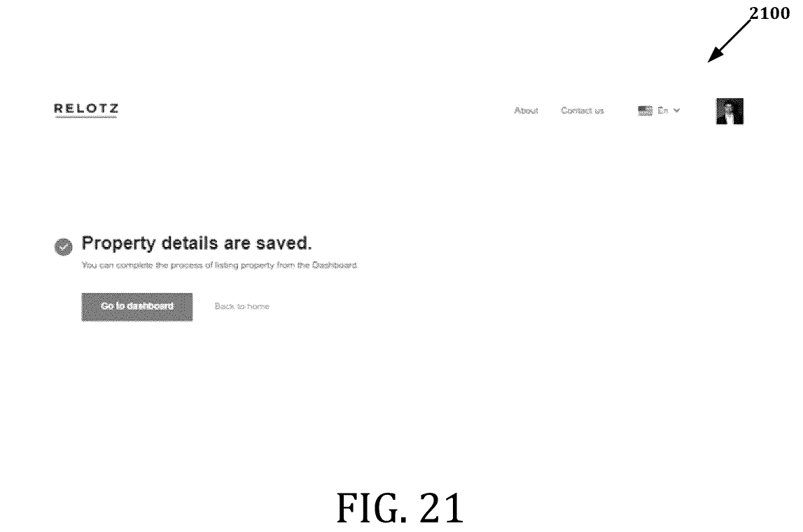

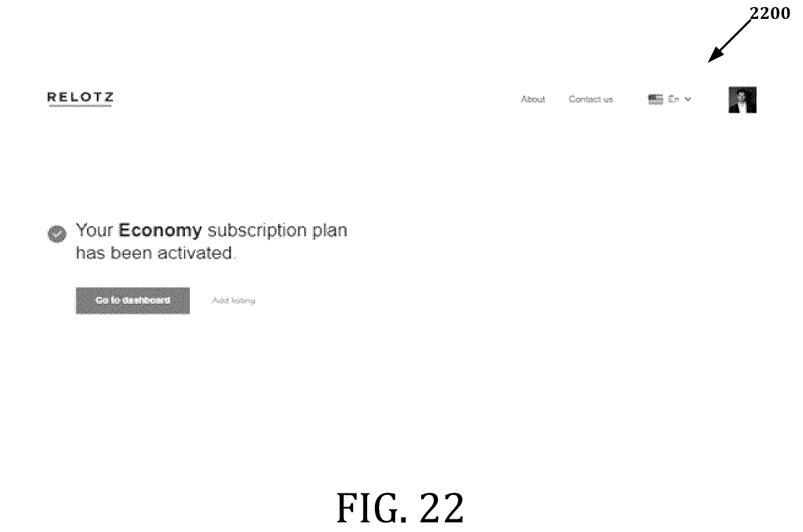

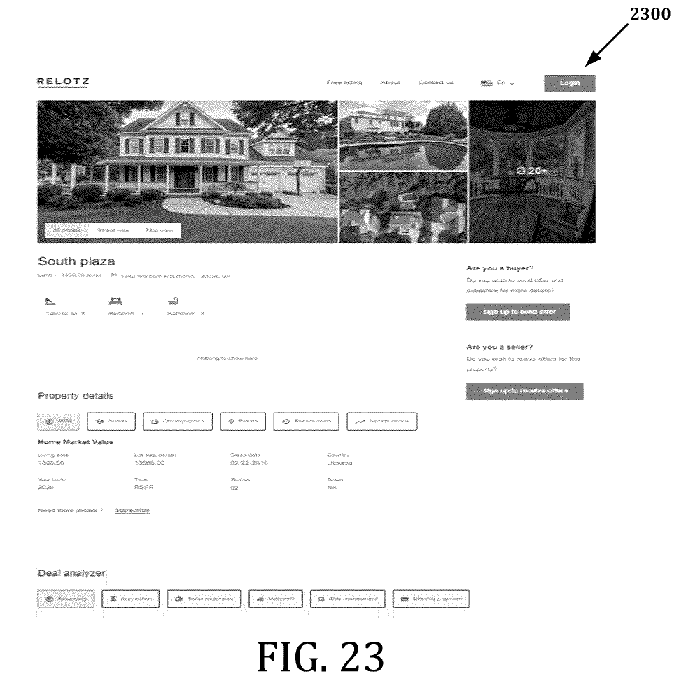

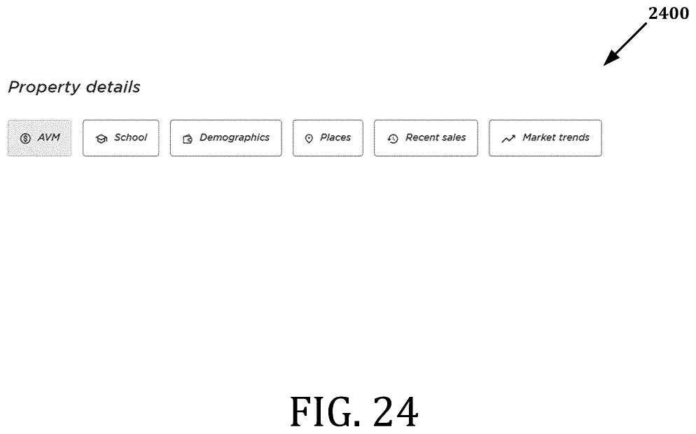

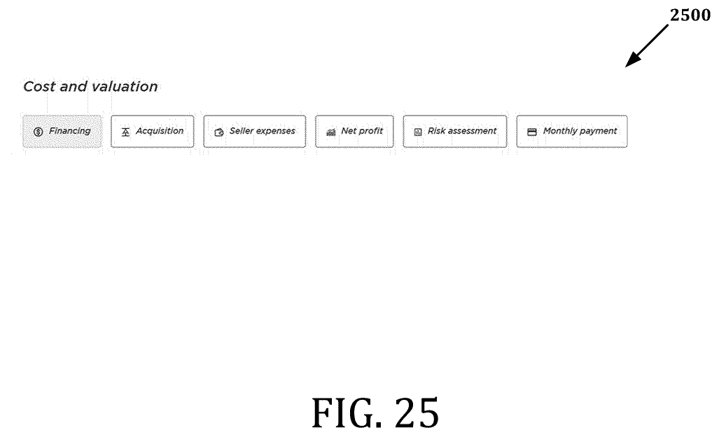

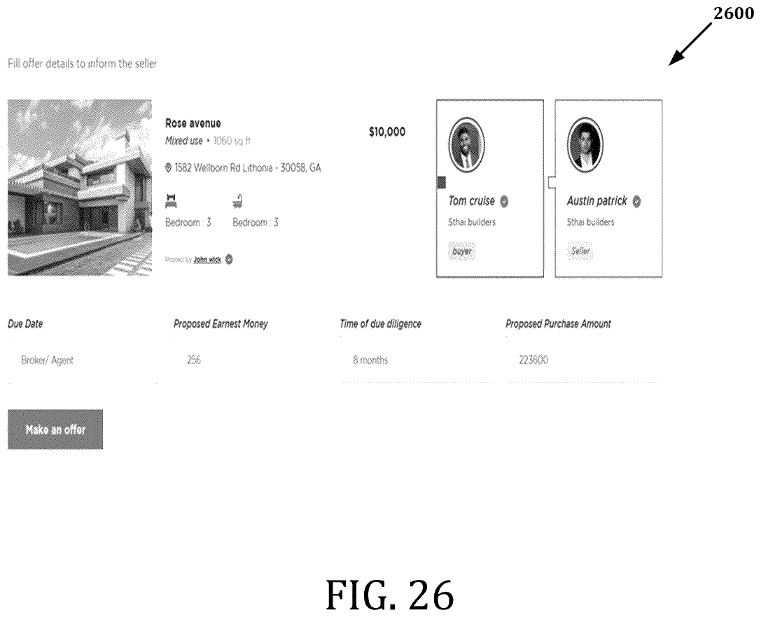

With reference now to the drawings, and in particular FIG. 1 through FIG. 27 thereof, examples of the wireless platform for providing interactive real estate transactions and the principles and concepts thereof will be described.

The system and methods disclosed herein can be described as a hardware and/or software platform system that is based on wireless communications, including software portals, computer software applications (apps), and a backend system, which can be used to provide interactive real estate transactions. Thus, the disclosed embodiment provides a technology platform that efficiently and interactively manages the end-to-end real estate transaction process (e.g., offer and sale of a real estate property) directly between a buyer and an owner/seller.

In an embodiment, the real estate transaction platform supports hardware, portals that can be accessed on a mobile computing device, and software applications (e.g., mobile “apps”) that can be installed on a mobile computing device. The end user software that is supported by the real estate transaction platform may be used by buyers that are interested in offering to purchase real estate property, and owners/sellers of real estate property that are interested in offering the sale of real estate property. For example, the real estate property platform provides a buyer portal for users of the system to access interactive features related to buying real estate property, such as: subscribing to view real estate property listings; and submitting an offer to purchase a real estate property. Additionally, the real estate property platform provides an owner/seller portal for users of the system to access interactive features related to selling real estate property, such as, such as: listing real estate properties for sale; and view offers on listed real estate properties.

In an embodiment, the real estate transaction platform system includes a backend system that that provides various features necessary to properly support the end-to-end real estate transaction between a buyer and an owner/seller, such as: coordination of stages for offers on sale of a real estate property (e.g., counter-offer, reject offer, accept offer); and coordination of closing actions associated with the sale of real estate property (e.g., earnest money, contract signing, etc.). Also, according to the embodiments, the real estate transaction platform system leverages wireless communications, such as Internet connectivity, in order to support the interactive communication between elements of the platform, such as messaging and/or notifications related to offers on sale of a real estate property between the owner/seller and the buyer.

Typically, real estate negotiations between an owner/seller of a real estate property who is offering the property for sale, and a buyer that may be interested in purchasing the property generally relies on the involvement of human real estate agents. Even some Internet based systems that allow real estate property searches, which are currently used in the market, require that the listed properties (e.g., real estate properties offered for sale) be submitted and maintained by a listing agent. Subsequently, if a person finds a real estate property that is listed for sale using one of these current systems, the listing agent must be contacted in order to further inquire about the property and submit an offer. Furthermore, in some instances, these current systems restrict their access only to registered real estate agents. In other words, only real estate agents can use many of the current systems to access and/or search through listed real estate properties. Thus, these current systems often prevent communication and/or negotiations directly between the buyers and the owner/sellers.

Moreover, in many cases notwithstanding the use of computer-based systems, a real estate transaction between a buyer and an owner/seller is primarily a manual process. For instance, in order to complete a real estate transaction, a real estate agent may need to draft contracts (e.g., filling out a standard form) which is then transmitted via email or fax to the listing agent. Upon receipt, the listing agent prints and reviews the document with the seller, and makes any changes to the terms of the printed document that he or she desires. Once the changes are made, the listing agent may submit a counter-offer to the buyer's agent in a similar fashion; this process typically repeats itself three to five times until a transaction is fully negotiated. This process is costly, unsecure, inefficient, and generally results in a final document which is both messy and difficult to interpret, thereby exposing the parties and their agents to unnecessary risk of dispute and litigation. Additionally, this process does not scale well, and can make it very difficult to manage multiple ongoing or potential negotiations.

The disclosed real estate transaction platform system addresses these aforementioned challenges and provides a computer-based system and computerized process of performing real estate transactions directly between a buyer and an owner/seller in a manner that mitigates inefficiencies, such as potential miscommunication, delay, and overhead expenses in the process. Referring now to FIG. 1, an example of a communication environment 100 in which embodiments of the real estate transaction platform system 110, disclosed herein, may be implemented. The real estate transaction platform system 110 provides several features that add automation, security, and increased efficiency to aspects of real estate transactions that are not currently available. As alluded to above, the real estate transaction platform system 110 is distinctly designed to provide a technology platform that consistently, efficiently, and interactively manages the end-to-end real estate transaction process, including negotiating an offer for sale of real estate property.

As previously described, traditional real estate negotiations typically involve having real estate agents that serve intermediaries between a buyer and an owner/seller during a negotiation for real estate property. During this process, communication between the buyer and the owner/seller passes through one or more agents, which often causes delays in the overall process and increases the amount of time that it takes to complete the real estate transaction. Furthermore, the conventional “in-person” approach for real estate transactions is susceptible to human error, such as incorrect/incomplete paperwork, miscommunication, and the like. In contrast, the disclosed real estate transaction platform system 110 realizes multiple advantages associated with leveraging a computer-based platform for optimizing the real estate transaction process. In detail, by focusing on direct communication between the buyer via a buyer portal 135 and the owner/seller via a seller portal 145, the real estate transaction platform system 110 provides enhanced accuracy, consistency, and efficiency in the real estate transaction process.

Furthermore, the real estate transaction platform system 110 is designed to provide multiple functions related to managing and executing a real estate transaction, such as: coordinating real estate transactions between buyer and owner/seller, including offers for purchase of real estate properties and/or negotiating sale of real estate property; maintaining subscriptions and real estate properties associated with users of the system, such as providing views of real estate properties listed by a user (e.g., owner/seller); and coordinating closing actions associated with a real estate transaction, such as processing earnest money payment associated with the sale of a real estate property (e.g., subsequent to accepted offer). It should be appreciated these aforementioned advantages are not intended to be limiting, and that the real estate transaction platform system 110 provides other benefits beyond those explicitly disclosed herein.

The real estate transaction platform system 110 can be a network-based platform (e.g., Internet) that is accessed and interacted with by a plurality of distributed users. Typically, users must complete a sign-up process with the real estate transaction platform system 110, which can include creating an account/subscription in order to access the features provided by the real estate transaction platform system 110. For example, users of the system 110 can enable end user devices, such as laptop computers, smartphones, and the like to wirelessly connect to a communication network 120, such as the Internet, and thereby connect to the real estate transaction platform system 110. FIG. 1 illustrates a mobile computer device 130, shown as a smartphone, that can be used by an owner/seller of a real estate property 150, where the owner/seller is interested in listing their real estate property 150 on the real estate transaction platform system 110. FIG. 1 also illustrates a mobile computer device 140, also shown as a smartphone, that can be used by a buyer that may be interested in purchasing the real estate property 150.

Referring to the example, the mobile computer devices 130, 140 can establish wireless connections to real estate transaction platform system 110 via the communication network 120, such as the Internet. Thus, the real estate transaction platform system 110 can include a web-based platform that can be accessed remotely by a software, such as applications and portals, depicted as seller portal 145 and buyer portal, that is installed on and/or accessible via the mobile computer devices 130, 140 respectively, in order to control aspects of the real estate transaction process, such as listing real estate properties for sale, submitted and/or review offers for purchase of real estate properties, and the like. FIG. 1 shows that an owner/seller of a real estate property 150 can have a mobile computer device 140 to access a seller portal 145 installed thereon. Additionally, FIG. 1 shows that a buyer can have a mobile computer device 130 to access a buyer portal 135 installed thereon.

The communication network 120 can facilitate access and communication to global Wide Area Networks (WAN), such as the Internet, and supports any number of wireless communication protocols such as: WIFI, BLUETOOTH, ZIGBEE, cellular based protocols, and the like. It should be appreciated that the mobile computer devices 130, 140 may be implemented as various numbers of mobile and/or portable computing devices that are suitable for air travel, such as a smartphone, a tablet, a laptop, or a wearable device such as a smartwatch.

Accordingly, the mobile computer devices 130, 140 can utilize software applications and portals, namely the buy portal 135 and the seller portal 145 respectively, that implement a graphical user interface (GUI) and user experience (UX) environments of the real estate transaction platform system 110 to allow users to access, view, and interact with its features over the distributed communication network 120 (e.g., Internet).

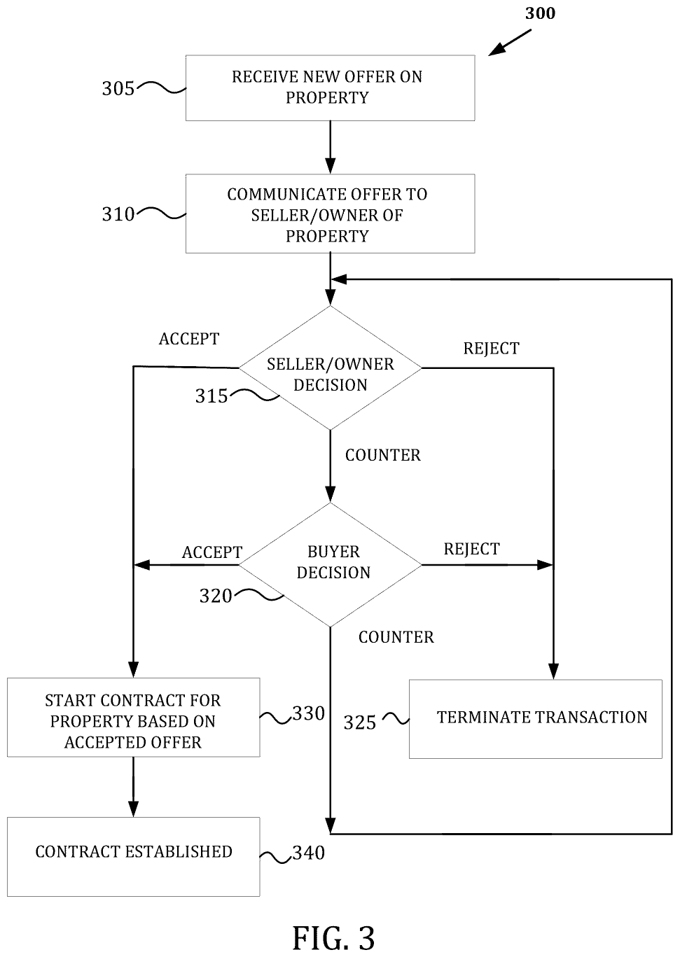

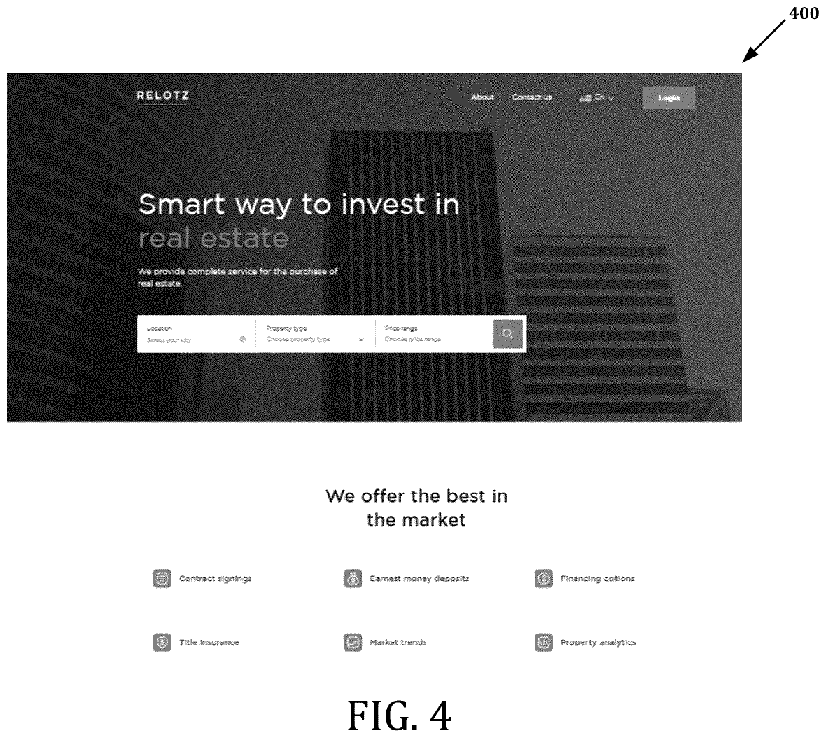

Examples of GUIs that may be implemented by the real estate transaction platform system 110 that buyers and owners/sellers to interact with various features supported by the system 110, for example being access via the buyer portal 135 and the seller portal 145, are depicted in FIG. 4-FIG. 23. For example, the GUIs supports computer-based interactions that enables buyers and/or owners/sellers to directly communicate with each other during the process of: listing real estate properties for sale; finding real estate properties listed for sale; reviewing offers for real estate properties; and negotiating the sale of real estate property. It should be understood that the GUIs illustrated are merely exemplary and are not intended to be limiting. Accordingly, the real estate transaction platform system 110, as disclosed herein, can support other GUIs and/or features that are not illustrated in FIG. 3-FIG. 23.

According to the embodiments, the seller/owner portal 145 is an element of the system's 110 platform that supports interactions for tasks that are associated with the owner/seller in a real estate transactional process, such as listing real estate properties for sale. FIG. 1 depicts the seller portal 135 as supporting features that include, but are not limited to: uploading listings for real estate properties for sale to the system 110; viewing offers submitted to the system 110 for purchase of listed real estate properties; and interacting with real estate transactions (e.g., accepting/rejecting/countering offers) that are supported by the system 110.

An owner/seller can connect to the Internet 120 via their computer device 140, and utilize the seller portal 145 on their mobile computer device 140 to access the real estate transaction platform system 110 and utilize the system's 110 features. For example, the owner/seller can use their computer device 140 to access a web page that is maintained by the system 110, and enter credentials (e.g., username, password) associated with a previously registered account for that user on the system 110 in order to access their seller portal 145 page. In an embodiment, the seller portal 145 displays a graphical user interface (GUI), such as a dashboard, which is maintained by the system 110 and displays a list of all of the properties that that owner/user has been uploaded to the system 110. For instance, the owner/seller of real estate property 150 may have previously used their seller portal 145 to upload a listing describing the details (e.g., location, offer price, etc.) associated with the property 150 (depicted in FIG. 1 as a house). Then, upon a subsequent instance of logging-in to the system 110, the real estate property 150 would be displayed in the seller portal 145 as one of the listed properties (e.g., properly listing webpage) that corresponds to that seller that are available to be searched and/or access on the system 110. Additionally, any offers that have been submitted to the real estate transaction platform system 110 for a real estate property that has been listed by that owner/seller may be accessed and/or viewed via their seller portal 145. Referring back to the previous example, if a buyer submits an offer for real estate property 150 (that has been listed by the owner/seller) to the system 110, then that offer would be visibly displayed via the seller portal 145. In an embodiment, the owner/seller can utilize their seller portal 145 to solicit offers privately by inviting specific buyers on the system 110 to purchase their properties (e.g., wholesalers, inventors, etc.). Thus, the seller portal 145 allows the owner/user to access and/or view all offers across their listed properties that they have received from different buyers directly on their computer device 140 (via the system 110) and without requiring any intermediary actions by a real estate agent.

The buyer portal 135 is an element of the system's 110 platform that supports interactions for tasks that are associated with the buyer in the real estate transactional process, such as searching/viewing real estate properties listing for potential purchase. FIG. 1 depicts the buyer portal 135 as supporting features that include, but are not limited to: subscribing to searching and/or viewing real estate properties listings on the system 110; submitting and/or viewing offers to system 110 for purchase of listed real estate properties; interacting with real estate transactions (e.g., accepting/rejecting/countering offers) that are supported by the system 110.

In some embodiments, there are other types of features that may be related to the purchase of real estate property, which are accessible and/or enabled via the buyer portal, such as an instant purchase, and financing capabilities. The instant purchase (or “click-to-buy”) feature allows a buyer to make a quick decision during the offer/purchase process and purchase the property instantly. For example, a buyer can “click” on a listed property that is displayed on their mobile computer device 130 to forego multiple rounds of submitting/reviewing offers in order to quickly purchase that real estate property. Regarding the financing capabilities, the system 100 supports various financing operations that can be employed by the buyer and/or the seller, including: instance finance options which offers finance services to buyers within a proper legal process; cash to close (e.g., cash settlements); earnest deposit service allowing sellers to deposit an amount of earnest money as calculated by the system 100; and debt services.

As an example, a buyer can connect to the Internet 120 via their computer device 130 and utilize the buyer portal 135 on their mobile computer device 130 to access the real estate transaction platform system 110 and utilize the system's 110 features. The buyer can use their computer device 130 to access a web page that is maintained by the system 110, and enter credentials (e.g., username, password) associated with a previously registered account for that user on the system 110 in order to access their buyer portal 135 page. Subsequently, the buyer portal 135 displays GUI, or dashboard, which is maintained by the system 110 and displays a list of all of the properties that that seller has subscribed to. For example, the buyer may initially access a front web page (e.g., home page, landing page) for the system 110 on their computer device 130, and log-in to access their buyer portal 135 that displays a real estate property search function. The searching feature of the system 110 enables the buyer to search through the listed properties that are being offered for sale (e.g., uploaded to the system 110 by owners/sellers) on the system 110 based on their subscription, and/or enables the system 110 to automatically provide recommendations of real estate properties that the buyer may be interested in based on certain user criteria (e.g., location, sale price) that can be maintained by the system 110. In some embodiments, the system 110 allows the buyer to enter search parameters for a real estate property such as: the address for a property, location, parcel number, a map view, zoom view, and the like. Continuing with the prior example, based on the buyer's search parameters that they have entered into their buyer portal 135, the system 110 may automatically retrieve data corresponding to the real estate property 150 (e.g., within a search radius of the entered address), where the real estate property 150 was previously listed by the owner/seller via their seller portal 145. Once the data for real estate property that the buyer may be interested in purchasing, based on their search, is retrieved by the system 110 and displayed via the buyer portal 135, then the buyer has the ability to select one of these real estate properties and submit a corresponding offer for purchase to the system 110. According to the embodiments, a buyer can utilize the buyer portal 135 to access and/or view different properties that they have subscribed to and/or been recommended by the system 110, or privately offered by seller; and access and/or interact with offers that they have submitted for different properties on the system 110. Referring to the previous example, if the buyer previously submitted an offer for real estate property 150 (that has been listed by the owner/seller) to the system 110, then that open offer would be visibly displayed via the buyer portal 145. Thus, the buyer portal 145 allows the buyer to view listed real estate properties, and submit offers on these listed properties (which will be communicated directly to buyers directly) on their computer device 130 (via the system 110) and without requiring any intermediary actions by a real estate agent.

The real estate transaction platform system 110 can be a backend computer system(s), such as a server, that implements functionality and features that support computerized/automated real estate transaction. A key feature of the real estate transaction platform system 110 is facilitating a full real estate transaction directly between buyers and sellers. Thus, referring back to the previous example, the system 110 can enable messaging (e.g., e-mails, texts, chats) and notifications between the computer system 140 of the owner/seller and the computer system 130 of the buyer that allows them to negotiate an offer for the real estate property 150, for instance where the buyer submits an offer on the property 150, the seller can review and accept the offer on the property 150, and the sale of the property can be closed (e.g., contracts electronically signed, payments electronically processed, etc.). Accordingly, the real estate transaction platform system 110, as disclosed herein, allows buyers and sellers to directly interact and efficiently and securely conduct a real estate transaction (e.g., send and receive offers to purchase real estate), while the system 110 has removed the process of using real estate agent to intermediate the transaction.

Additionally, the real estate transaction platform system 110 supports an application programming interface (API) from data sources that captures hundreds of data points, namely real-time data that may be related to a real estate property, which ultimately can be accessed and viewed by potential purchasers. Examples of various types of data points corresponding to a real estate property that are captured and/or generated by the system 110 can include but is not limited to: nearby schools information; nearby places/points of interest; recent sales; demographic data; market trends; and the like. Generally, data points are crucial information that is related to a real estate property, which is collectively presented via the system 110 in a manner that eliminates the need to for a user to search and gather hundreds of data points from disparate external sources. By providing these data points, the system 110 presents additional information about real estate property that increases the buyer's confidence, contributes supplemental data for a purchase decision, as well as providing several other benefits for investors, sellers, and buyers. In an embodiment, these aforementioned data points can be viewed and/or accessed from the system 110 as a part of a paid subscription package. Therefore, by providing data points in addition with other features such as financing, acquisition cost, net profit, risk assessment, and seller expenses for real estate properties, the system 100 fully supports individuals end-to-end in the real estate sell/purchase process.

Thus, the system 110 may realize several advantages in real estate negotiations, such as eliminating the commission of real estate agents and allows both parties to negotiate by sending counter offers until either party accepts. The system 110 can also extends its capabilities beyond buyers, sellers in order to coordinate actions across a plethora of users that may be involved in completing transactions, such as closing attorneys, lenders, financial institutions (e.g., banks) to complete the life cycle of the real estate negotiations and consummate a transaction. To support these functions, information that is pertinent to real estate transactions, such as user accounts (e.g., username, password), offers, contracts, notifications, properties, and the like may be maintained by the system 110 on a storage system, illustrated as database 115.

In some embodiments, the system 100 can be utilized by third party, such as a real estate brokers/agents. For example, a real estate agent may employ the real estate transaction platform system 110 to further their client base and leverage the system's 110 various interactive capabilities, where the system 110 allows the agent to perform actions such as work with a plurality of property owners, send/receive offers, and interact with blind offers. According to this embodiment, a broker/agent may be acting on behalf of a seller/buyer, and ultimately using the features of the system 110 for their clients. Further, in the third party (e.g., agent/broker) embodiment, the system 110 may perform various verification/authentication functions to ensure that the third party using the system 110 is in fact authorized to act on behalf of a real buyer/seller prior to being allowed to complete any actions on the system. Consequently, the real estate transaction platform system 110, as disclosed herein, provides a technology platform that consistently, efficiently, and interactively manages the end-to-end real estate transaction process.

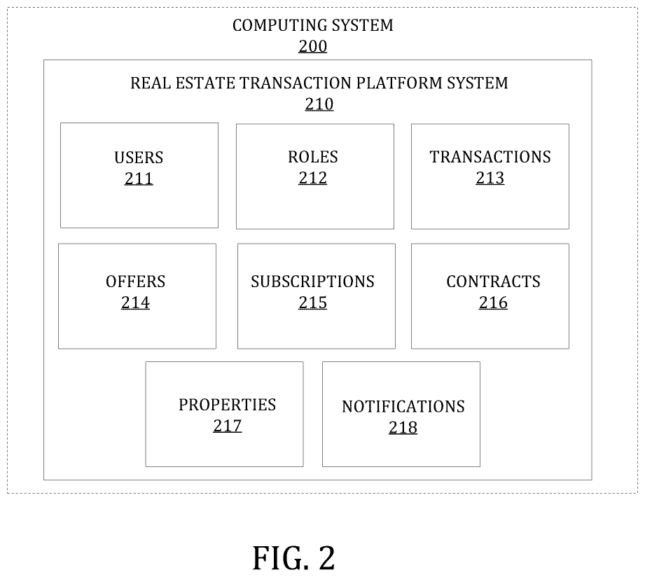

FIG. 2 illustrates an example computer system, depicted as a computing system 200 that is configured to implement the real estate transaction platform system 210, in accordance with embodiments of the present invention. The computing system may be a computing device, such as server computer, or the like, and may include processors, which may be a semiconductor-based microprocessor, a central processing unit (CPU), an application specific integrated circuit (ASIC), a field-programmable gate array (FPGA), and/or another hardware device. FIG. 2 depicts that the computing system 200 includes several modules 211-218, that can be implemented as a hardware, such as a semiconductor-based microprocessor, a central processing unit (CPU), an application specific integrated circuit (ASIC), a field-programmable gate array (FPGA), and/or another hardware device, software, firmware, or any combination thereof on the computing device 200 in order to implement the functions and features of the real estate transaction platform system 210.

The modules 211-218 of the computer device 200 may be implemented, in whole or in part, as a non-transitory computer readable medium that may have stored thereon machine-readable instructions executable by the processors of the system 200. Examples of the machine-readable instructions are shown as: a user module 211; a roles module 212; a transactions module 213; a offers module 214; a subscriptions module 216; a properties module 217; and a notifications module 218. Examples of the non-transitory computer readable mediums that may be used to implement the modules 211-218 may include an electronic, magnetic, optical, or other physical storage device that contains or stores executable instructions. For example, the non-transitory computer readable medium may be a Random-Access memory (RAM), an Electrically Erasable Programmable Read-Only Memory (EEPROM), a hard disk, an optical disc, or other type of storage device. The processor of the computing device 200 may fetch, decode, and execute the machine-readable instructions implemented by the modules 211-218 in order to execute the functionality of the real estate transaction platform system 210 disclosed herein, such as coordinating real estate transactions directly between buyers and owners/sellers, eliminating the need for real estate agents in the process.

Referring now to FIG. 3, an example of a method 300 for implementing aspects of the computer-based real estate transaction process, as disclosed herein, is shown. The method 300 can be implemented via the real estate transaction platform system (shown in FIG. 1).

The process 300 begins at operation 305, where an offer to purchase a real estate property is received. For example, a buyer who is interested in buying a property that is listed on the system may initiate an offer to the seller, by submitting an offer for that property to the system via their buyer portal.

Next, at operation 310, the offer is communicated to the seller corresponding to that real estate property. In an example, the seller can access and/or view one or more offers (uploaded by buyers) to purchase their real estate property via their seller portal, and may be notified of new offers by the system (e.g., email, text, chat, etc.).

The process 300 can continue to operation 315, where the owner/seller responds to a received offer on their property with a decision. The system allows various types of interactions for an open initial offer by the owner/seller. Consequently, the owner/seller may utilize the system to select at least one response to the initiated offer, including: rejecting the initial offer; submitting a counteroffer to the initial offer; and accepting the initial offer.

In response to the owner/seller selecting to reject the offer, the process 300 moves to operation 325 where the transaction is terminated. Alternatively, in response to the owner/seller submitting a counteroffer to the initial offer, the process 300 continues to operation 320 where this counteroffer is presented to the buyer and a corresponding response to the counteroffer may be entered by the buyer. Similar to the owner/seller, the system also allows various types of interactions that the buyer can submit to a counteroffer sent by the owner/seller. That is, the buyer may select at least one response to the counteroffer, including: rejecting the counteroffer offer; submitting an additional counteroffer to the counteroffer offer; and accepting the counteroffer. For instance, the buyer can counter the counteroffer from the seller, which causes the process to return back to operation 315. Thus, operations 315-320 are illustrated as a sub-process that allows for the buyer and seller to go through several iterations of receiving offers and countering offers until an agreement on the negotiation, such as an agreed purchase price, allows the process 300 of the real estate transaction to proceed in a conclusive manner. For example, if an offer (or one of the counteroffers) is rejected by a buyer or seller at any point in the negotiation, then the process continues to operation 325 where the transaction is terminated. Alternatively, if an offer (or one of the counteroffers) is accepted by a buyer or seller at any point in the negotiation, then the process continues to operation 330 where closing actions to complete the purchase of the real estate property can be executed.

At operation 330, a contract based on the accepted offer (or counteroffer) can be drafted. Operation 330 can involve other functions of the system, such as contacting and coordinating tasks with attorneys, as well as electronically creating, transmitting, and signing, contacts and other documents that are related to closing the purchase of the real estate property and completing the transaction. In some embodiments, operation 330 can include offline operations (e.g., physically signing hard copies of contacts).

Subsequently, process 300 can continue to operation 340 where the contact is established and the transaction is completed. According to the embodiments, operation 340 can include actions such as processing payments, and the like, which are required to be performed in order for the purchase of the real estate property to be legally finalized and complete the transaction.

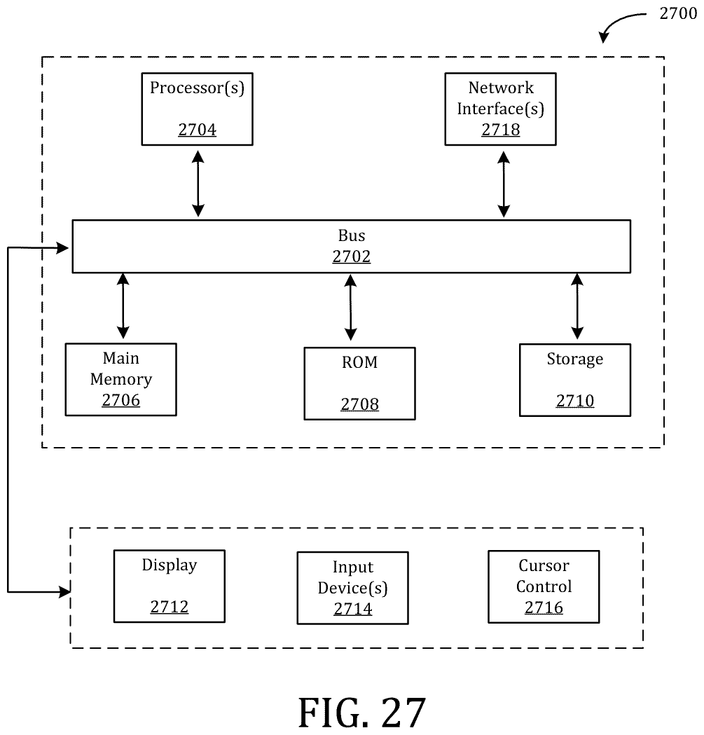

FIG. 27 depicts a block diagram of an example computer system 2700 in which the disclosed aspects of the real estate transaction platform system (shown in FIG. 1) may be implemented. Furthermore, it should be appreciated that although the various instructions are illustrated as being co-located within a single processing unit, there may be some implementations in which processor(s) includes multiple processing units, allowing one or more instructions may be executed remotely from the other instructions.

The computer system 2700 includes a bus 2702 or other communication mechanism for communicating information, one or more hardware processors 2704 coupled with bus 2712 for processing information. Hardware processor(s) 2704 may be, for example, one or more general purpose microprocessors.

The computer system 2700 also includes a main memory 2706, such as a random-access memory (RAM), cache and/or other dynamic storage devices, coupled to bus 2702 for storing information and instructions to be executed by processor 2704. Main memory 2706 also may be used for storing temporary variables or other intermediate information during execution of instructions to be executed by processor 2704. Such instructions, when stored in storage media accessible to processor 2704, render computer system 2700 into a special-purpose machine that is customized to perform the operations specified in the instructions.

The computer system 2700 further includes a read only memory (ROM) 2708 or other static storage device coupled to bus 2702 for storing static information and instructions for processor 2704. A storage device 2710, such as a magnetic disk, optical disk, or USB thumb drive (Flash drive), etc., is provided and coupled to bus 2702 for storing information and instructions.

The computer system 2700 may be coupled via bus 2702 to a display 2712, such as a liquid crystal display (LCD) (or touch screen), for displaying information to a computer user. An input device 2714, including alphanumeric and other keys, is coupled to bus 2702 for communicating information and command selections to processor 2704. Another type of user input device is cursor control 2716, such as a mouse, a trackball, or cursor direction keys for communicating direction information and command selections to processor 2704 and for controlling cursor movement on display 2712. In some embodiments, the same direction information and command selections as cursor control may be implemented via receiving touches on a touch screen without a cursor.

The computing system 2700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interruptions. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 2700 may implement the techniques described herein using customized hard-wired logic, one or more ASICs or FPGAs, firmware and/or program logic which in combination with the computer system causes or programs computer system 2700 to be a special-purpose machine. According to one embodiment, the techniques herein are performed by computer system 2700 in response to processor(s) 2704 executing one or more sequences of one or more instructions contained in main memory 2706. Such instructions may be read into main memory 2706 from another storage medium, such as storage device 2710. Execution of the sequences of instructions contained in main memory 2706 causes processor(s) 2704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 2710. Volatile media includes dynamic memory, such as main memory 2706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 2702. Transmission media can also take the form of acoustic or light waves, such as those generated during radio-wave and infra-red data communications.

The computer system 2700 also includes a communication interface 2718 coupled to bus 2702. Network interface 2718 provides a two-way data communication coupling to one or more network links that are connected to one or more local networks. For example, communication interface 2718 may be an integrated services digital network (ISDN) card, cable modem, satellite modem, or a modem to provide a data communication connection to a corresponding type of telephone line. As another example, network interface 2718 may be a local area network (LAN) card to provide a data communication connection to a compatible LAN (or WAN component to communicate with a WAN). Wireless links may also be implemented. In any such implementation, network interface 2718 sends and receives electrical, electromagnetic, or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local networks and Internet both use electrical, electromagnetic or optical signals that carry digital data streams. The signals through the various networks and the signals on network link and through communication interface 2718, which carry the digital data to and from computer system 2710, are example forms of transmission media.

The computer system 2700 can send messages and receive data, including program code, through the network(s), network link and communication interface 2718. In the Internet example, a server might transmit a requested code for an application program through the Internet, the ISP, the local network and the communication interface 2718.

The received code may be executed by processor 2704 as it is received, and/or stored in storage device 2710, or other non-volatile storage for later execution.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

What is claimed is:

1. A system, comprising:
a processor;
a memory on which are stored machine-readable instructions that when executed by the processor, cause the processor to:
receive data associated with one or more real estate properties from a first user; and
in response to receiving the data associated with one or more real estate properties, generating a real estate property listing to be access by a second user.

2. The system of claim 1, wherein the first user is a seller of the real estate property and the second user is a buyer of the real estate property.

3. The system of claim 1, wherein the data associated with one or more real estate properties is uploaded from a seller portal on a first computer device used by the seller.

4. The system of claim 2, wherein real estate property listing is accessed by a buyer portal on a second computer device used by the buyer.

5. The system of claim 4, wherein the seller portal displays data of one or more properties that have been uploaded by the seller.

6. The system of claim 5, wherein the buyer portals is associated with a subscription server that enables the buyer to access one or more real estate property listings.

7. The system of claim 6, wherein the buyer portal enables a real estate property searching function for the buyer to retrieve on or more real estate property listings.

8. The system of claim 7, wherein the buyer portal enables the buyer to submit search parameters into the real estate property searching function related to one or more real estate property listings.

9. The system of claim 8, wherein the searching criteria comprises one or more of: address, location, parcel number, map view, and zoom area.

10. The system of claim 9, wherein the seller portal enables the seller to submit a private invitation to a buyer for an offer on one or more real estate property listings.

11. The system of claim 10, wherein the buyer portal enables the buyer to receive automatic recommendations related to the one or more real estate property listings.

12. The system of claim 11, wherein the buyer portal enables the buyer to submit an offer on at least one real estate property listing.

13. The system of claim 12, wherein the buyer portal enables the buyer to submit an initial offer on at least one real estate property listing.

14. The system of claim 13, wherein the seller portal enables the seller to be notified and view the initial offer on at least one real estate property listing.

15. The system of claim 14, wherein the seller portal enables the seller to interact with the initial offer.

16. The system of claim 15, wherein the interactions comprise at least one of: accepting the initial offer; submitting a counteroffer; and rejecting the offer.

17. The system of claim 16, wherein the buyer portal enables the buyer to be notified and view the counteroffer from the seller on at least one real estate property listing.

18. The system of claim 17, wherein the buyer portal enables the buyer to interact with the counteroffer.

19. The system of claim 18, wherein the interactions comprise at least one of: accepting the counteroffer; submitting an additional counteroffer; and rejecting the counteroffer.

20. The system of claim 19, wherein the stored machine-readable instructions that when executed by the processor, further cause the processor to:
execute and coordinate closing actions related to the real estate transaction including processing payments, generating contracts, and communicating with attorneys.
